(19) United States
(12) Patent Application Publication
(10) Pub. No.: US 2021/0212799 A1
(43) Pub. Date: Jul. 15, 2021

(54) ENDOACTIVATOR TIPS FOR CLEANING DENTAL ROOT CANAL SYSTEM

(71) Applicants: Clifford J. Ruddle, Santa Barbara, CA (US); Nathan Y. LI, Las Vegas, NV (US)

(72) Inventors: Clifford J. Ruddle, Santa Barbara, CA (US); Nathan Y. LI, Las Vegas, NV (US)

(21) Appl. No.: 17/146,486

(22) Filed: Jan. 11, 2021

Related U.S. Application Data
(60) Provisional application No. 62/959,164, filed on Jan. 9, 2020.

(51) Int. Cl. A61C 5/50; A61C 17/20

(52) U.S. Cl. CPC A61C 5/50; A61C 17/20

(57) ABSTRACT

An endoactivator tool for activating intracanal reagents in a dental root canal system during endodontic procedures, with the tool comprising a flexible activator tip having a proximal end connected to a coupler to a driver and extending distally from the coupler to terminate at a most distal end, wherein the activator tip being shaped such that when the driver is activated, the coupler will induce vibrations in at least an activating portion of the activator tip, wherein the activating portion comprises at least one curved offset section displaced from the vibration axis in a plane including the vibration axis, wherein the activating portion has a length extending through a prepared dental root canal and a diameter sufficiently smaller than the diameter of the prepared root canal such that the activating portion can vibrate in the dental root canal when activated, and wherein the activating portion being made from a flexible, non-cutting material having a hardness less than the hardness of a root canal wall such that the material will not damage the walls of the canal during use of the tool. The proximal end of the activating portion is connected to a location on the coupler displaced off the vibration axis, and/or the most distal end of the activating portion extends off the vibration axis when the activator tip is at a state not being inserted into a dental root canal. The longitudinal axis of the curved section of the activating portion meanders in a sinusoidal profile.

### PRIORITY CLAIM

This application claims the priority of U.S. Provisional Patent Application No. 62/959,164 filed on Jan. 9, 2020, which is fully incorporated by reference as if fully set forth herein. All publications noted below are fully incorporated by reference as if fully set forth herein.

### BACKGROUND OF THE INVENTION

### Field of the Invention

The present invention is directed to improved dental instruments for cleaning dental root canals, more particularly endodontic activator (endoactivator) tools having tips with improved structures to effect improved cleaning of root canals.

### Description of Related Art

Dental root canal treatment generally involves three stages: shaping, cleaning and obturation (generally involving filling and sealing). FIG. 1 is a schematic sectional view of a human tooth (e.g., a molar). As shown, the tooth T has a crown (enamel) portion C protruding above the gum G. As shown, in the shaping step, the crown C has been drilled open to expose the internal tooth cavities, which include a pulp chamber P below the crown C, and root canal spaces R. The ultimate objective of root canal treatment is to eliminate the infection inside the dental root system and to tightly seal or obturate the root canal system, in three dimensions (3D). The internal space of a root canal involves a very complex, confined, hard to reach system. Many tiny internal fissure-like spaces cannot be reached by mechanical means. The internal wall structure of a root canal is comprised of bone like hard tissue with many tiny tubal openings or microscopic channels called dentinal tubal.

In the shaping stage, current practices include shaping the root canal system main space/canal with a rotary NiTi files. Infected pulp tissues, bacterial fragments, among other infected debris form a very sticky layer called smear layer which attaches to root canal internal wall surface and covers the many dentinal tube openings.

After the root canal spaces have been shaped using a file, they are thoroughly cleaned, to prepare for obturation (filling and sealing with a compatible material). The cleaning step involves chemical solution irrigation of the root canal space. In the cleaning stage, failure to completely clean the root canal system in 3-D would lead to bacteria recolonization inside the root canal system, which would result in re-infection and possible loss of the tooth. Due to the very limited root canal space and very sticky nature of smear layer, the current practice is to clean and disinfect the shaped root canal space is by irrigating the shaped root canal space using reagents such as solutions of Ethylenediaminetetraacetic acid (EDTA), Sodium Hypochlorite, and/or Peroxide for the purpose of dissolving the smear layer and killing bacteria with singular oxygen. Repeated irrigations with fresh reagent solutions in adequate volumes are required for proper disinfection procedure.

To further ensure adequate fresh reagent exchange and singular oxygen release inside the tiny root canal space, additional means are employed to facilitate this process, such as applying energy from sources including heat, light, and mechanical forces. These added energies, in conjunction with adequate and fresh reagents, will produce more agitations to irrigants in the root canal space to better loosen up and break down the smear layer, resulting in a better cleaned root canal space.

US Patent Publication No. 2019/0290397 to Bruder discloses a tip for use with a dental handpiece for cleaning and disinfecting tooth root canals, with the tip driven to rotate at high RPMs. At the time of the present application filing, which is more than 4 years from the earliest priority date of the Bruder patent application, the co-inventors herein are not aware of any tip that is commercially available conforming to the disclosure of the Bruder patent publication.

Referring to FIGS. 2A and 2B, Dr. Cliff Ruddle invented a sonic driven instrument 1 with a tapered cylindrical polymer tip 2 to be used inside a root canal space to agitate reagent and smear layer for debris removal and better cleaning. As driven by the driver 3, the polymer tip 2 vibrates inside the root canal space and create a vortex effect and induce cavitation in the reagent. The cavitation creates forces that agitates the reagent to loosen up smear layer and also causes the reagent to release more singular oxygen. Dr. Cliff Ruddle's efforts in the inventive sonic driven endoactivator system is documented in various US Patent publications, including: U.S. Pat. No. 6,179,617B1, U.S. Pat. No. 6,981,869B2, U.S. Pat. No. 7,261,561B2, U.S. Pat. No. 8,235,719B1, U.S. Pat. No. 8,388,345B2, US20060234183A1, US2010092922A1, US20120148979A1. Dr. Ruddle's polymer endoactivator tip has a round cross section throughout the full length of the active section of the tip, and it has a smooth surface as well (see, FIG. 1), which is driven to vibrate at sonic frequencies.

As discuss hereinbelow, Dr. Ruddle and the co-inventor in the present application invented endoactivator tips having improved structures that result in improved cleaning of dental root canal spaces, by taking into considerations of factors including shape, cross sections and surface textures of the tips, among other factors, which influence vibration and wave propagation efficiency for agitating reagents during cleaning in root canal spaces.

### SUMMARY OF THE INVENTION

The present application is directed to endoactivator tools having activating tip portion with improved structures that result in improved cleaning of dental root canal spaces, by taking into considerations of factors including shape, cross sections and surface textures of the tips, among other factors, which influence vibration and wave propagation efficiency for agitating reagents during cleaning in root canal spaces.

As disclosed in detail herein, the inventive endoactivator tool is for activating intracanal reagents in a dental root canal system during endodontic procedures, with the tool comprising a coupler, shaped and configured to receive or be received by a portion of a driver to positively connect the tool directly to a vibrated member of the driver, wherein the coupler has a vibration axis about which the coupler laterally oscillates to vibrate when the driver is activated; a flexible activator tip having a proximal end connected to the coupler and extending distally from the coupler to terminate at a most distal end, wherein the activator tip being shaped such that when the driver is activated, the coupler will induce vibrations in at least an activating portion of the activator tip, wherein the activating portion comprises at least one offset section displaced from the vibration axis when view at a first plane including the vibration axis, wherein the activating portion has a length extending through a prepared dental root canal and a diameter sufficiently smaller than the diameter of the prepared root canal such that the activating portion can vibrate in the dental root canal when activated, and wherein the activating portion being made from a flexible, non-cutting material having a hardness less than the hardness of a root canal wall such that the material will not damage the walls of the canal during use of the tool.

In one embodiment, the inventive endoactivator tool has an offset section that comprises at least one curved section, wherein a longitudinal axis running through the center of the body of the activating portion is curved when viewed at the first plane including the vibration axis. For example, the longitudinal axis of the curved section of the activating portion meanders laterally in a wavy, snaking manner when viewed at the first plane including the vibration axis, such as in a sinusoidal profile. The activating portion may have a first curved section closer to the proximal end and a second curved section closer to the most distal end, wherein the longitudinal axis at the first curved section and the longitudinal axis at the second curved section alternate in directions of curvature when viewed at the first plane including the vibration axis. In a specific embodiment, the longitudinal axis at the first curved section has a first curvature greater than a second curvature of the longitudinal axis at the second curved section. To improve agitation of reagents in a dental root canal system, the proximal end of the activating portion is connected to a location on the coupler displaced off the vibration axis, and/or the most distal end of the activating portion extends off the vibration axis when the activator tip is at a state not being inserted into a dental root canal. The activator tip may comprise a connecting portion at its proximal end connecting the activating portion to the coupler at the location displaced off the vibration axis.

To further enhance agitation effect, the activating portion is connected to the coupler at an angle with respect to the vibration axis when view at a second plane orthogonal to the first plane including the vibration axis.

The activator tip is shaped to transmit vibrations to the activating portion when activated; wherein the activating portion being shaped to transmit vibrations to induce cavitation and acoustic streaming in a fluid-filled dental root canal when vibrations of a sonic or ultrasonic frequency are induced in said activator tip to enhance deep lateral cleaning of the dental root canal. In a preferred embodiment, the activating portion is driven to vibrate substantially in a vibration plane including the vibration axis, wherein the vibration plane corresponds to the second plane orthogonal to the first plane including the vibration axis. In a specific embodiment, the activating portion is structured and shaped to effectively vibrate at sonic frequencies to clean the root canal system as driven by the driver driving at sonic frequencies.

Further, the activating portion may be made of a material and/or shaped and structured to transmit light and/or heat applied from the driver through the coupler of the activating portion. The activating portion can be made of one of a polymer, metal, or hybrid metal/polymer material. For example, the activating portion is made from a non-metallic material, such as plastic, nylon, or aromatic polyimide.

In one embodiment, the activating portion has a diameter at the most distal end of about 0.15 mm to about 1 mm. The activating portion may comprise a portion that is tapered along at least a part of its length. The taper of the activating portion may be constant along its length, or variable along at least a part of the length of the elongate member. The taper may be between about 0.02 mm/1.0 mm and about 0.06 mm/1.0 mm (or 2% taper to 6% taper, constant or variable within this range), tapering from a larger proximal end to a smaller distal end, wherein in a variable taper tip, the larger tapered section is closer to the distal end.

The activating portion is preferred to have a cross-section perimeter with a geometry that does not resemble a generally convex body having a smooth curved profile (curved surface in three-dimension) with smooth, gentle transitions of convex curvatures with respect the longitudinal axis (e.g., generally circular, elliptical, dumbbell, or a geometry without any straight line segment, representing more gentle, smoothly convex profiles, as compared to perimeters having corners or abrupt extensions/protrusions resembling protruding profiles that are relatively less gentle and less smooth profiles). Preferred geometries of the cross-section perimeter comprise more abrupt extensions/protrusions or corners defined by angled profiles (angled surfaces in three-dimension) of straight, concave and/or convex line segments resembling generally protruded profiles (protrusions or ridges on surfaces in three-dimension). In a specific embodiment, the activating portion has a cross-section perimeter with a geometry that is substantially a polygon (e.g., square, rectangle, pentagon, trapezoid, etc.), having line segments defining surfaces angled relative to one another. It is noted that the corners of the polygon may be slightly rounded or deburred, with a small curvature, to avoid a sharp, abrasive edge along the length of the activating portion. It has been found that the three-dimension surfaces of the activating portions having a cross-section perimeter with more abrupt profiles would produce increased agitation of a fluid-filled root canal system when the activating portions vibrate by the activating driver.

The inventive activator tip disclosed herein is applied to clean the root canal system of a tooth of a living patient. The present invention is further directed to a method for cleaning a root canal system of a tooth of a living patient prior to three-dimensional filling of the root canal system during an endodontic procedure; the method comprising: preparing an access cavity in the patient's tooth; exposing the orifice(s) of a root canal within the pulp chamber of the tooth; negotiating, shaping and finishing the preparation of the root canal; removing the pulp, smear layer, and if present, bacteria and related irritants from the root canal system; placing an irrigating solution in the root canal; inserting an activator tip as disclosed herein into the solution-filled root canal, such that the activating portion reaches substantially to the working length of the root canal, wherein the activator tip having an overall diameter at its most distal end less than the diameter of the apical end of the root canal such that the activating portion of the activator tip can oscillate within the canal when the activating portion is fully inserted in the root canal; and sonically energizing the activator tip to oscillate the activating portion within the root canal at sonic speeds to thereby agitate the solution in the root canal system.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like, corresponding or similar parts throughout the drawings.

FIG. 1 is a schematic sectional view of a human tooth, showing internal pulp chamber and root canals.

FIG. 2A is an elevational view of an endodontic activator developed by Dr. Cliff Ruddle; and FIG. 2B is a schematic view of the endodontic activator mounted to a sonic vibratory driver.

FIGS. 3A to 3E are schematic views of tip structures in accordance with embodiments of the present invention, each having a geometry with sharp angles and edges along the active working portion for better transverse vibration wave propagation in reagent in a root canal space.

FIGS. 4A to 4E are schematic views of tip structures in accordance with additional embodiments of the present invention, each having a geometry with an off-centered active working tip portion (activating portion) for vibrational agitation for greater and more random envelope of motion which causing more agitating force on reagent in a root canal space.

FIGS. 5A and 5B are schematic views depicting a driver device and a light emitting endoactivator tip in accordance with one embodiment of the present invention, producing photo-acoustic effect bringing agitating force and singular oxygen molecules to extremely hard to reach tiny spaces inside root canal system.

FIG. 6A is a photographic image of an experimental setup of a light emitting driver and endoactivator tip; FIGS. 6B and 6C are further graphical renditions of light emitting endoactivator tips on drivers.

FIGS. 7A and 7B are schematic views of an embodiment of an endoactivator tip in accordance with the present invention, including exemplary dimensions illustrating relative profiles of the geometry of the endoactivator tip; FIG. 7C is a schematic view of attachment of the coupler of the endoactivator tip of the present invention to a driver device.

### DETAILED DESCRIPTION OF THE PREFERRED EMBODIMENTS

This invention is described below in reference to various embodiments with reference to the figures. While this invention is described in certain embodiments for achieving this invention's objectives, it will be appreciated by those skilled in the art that variations may be accomplished in view of these teachings without deviating from the scope and spirit of the invention.

The present application is directed to endoactivator tools having activating tip portion with improved structures that result in improved cleaning of dental root canal spaces, by taking into considerations of factors including shape, cross sections and surface textures of the tips, among other factors, which influence vibration and wave propagation efficiency for agitating reagents during cleaning in root canal spaces.

Preliminary experiments show a new tip/rod design with different cross section geometries and surface textures can improve vibration/sound wave propagation rates many times higher, in turn, increases agitation forces inside a very confined root canal space to loosen up smear layer, forcing reagent releasing more singular oxygen, and resulting in better debris removal and disinfection of very hard to reach root canal spaces inside a very complex root canal system.

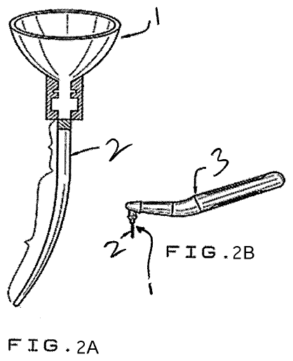

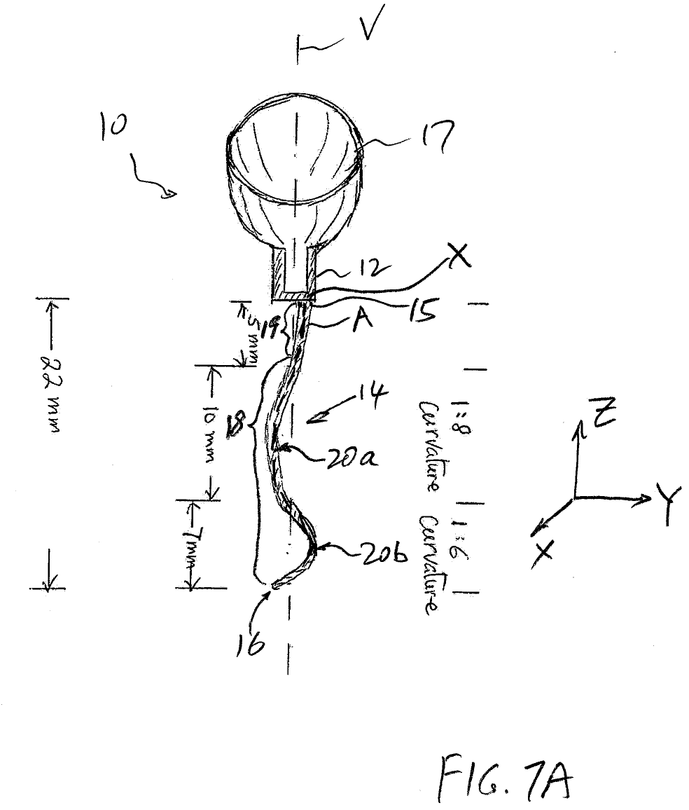

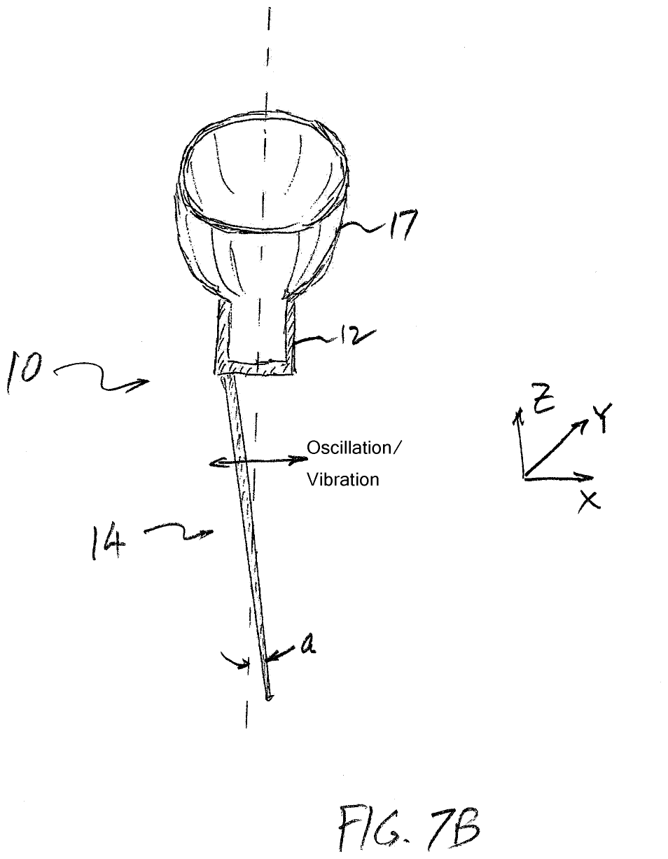

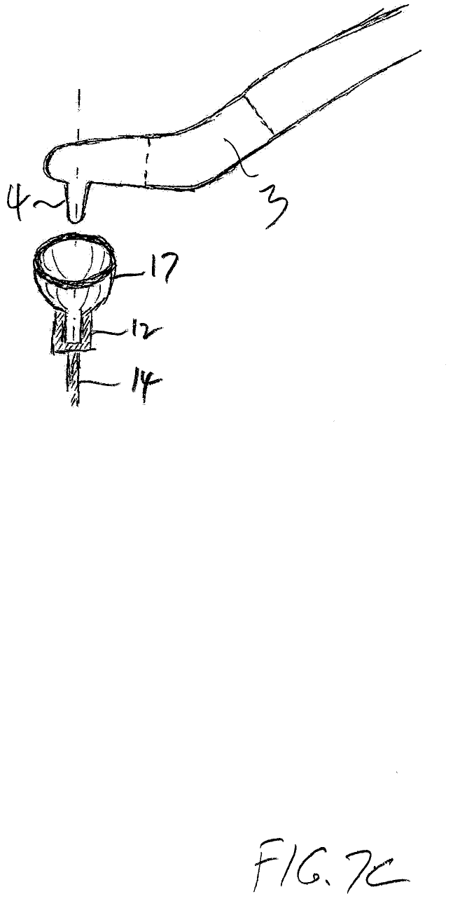

To amplify vibration wave's longitudinal and transverse propagation, inventors designed off-centered activating portion of the endoactivator tip/rod. When the endoactivator sonic engine (i.e., the device 3 discussed herein in reference to FIGS. 2 and 7C) generates vibrating motion, it drives the working portion (i.e., the activating portion) of the activator tip (e.g., polymer tip/rod) to vibrate in a more or less oscillating motion (or a slight circular motion around the vibration axis—a confined envelope of movement. By placing polymer tip/rod working portion off the center of tip's base (e.g., the working portion is off center with respect to the longitudinal axis of symmetry), the tip/rod will have much bigger and more random envelope of movement. In turn, this design introduces the transverse vibrating wave propagation even closer to the internal root canal wall where smear layer is attached to. The testing also shows this off-centered polymer tip/rod produces much bigger vortex funnel. As discussed below, the longitudinal working section of the tip/rod may be disposed off center or off the axis of the vibration axis. It is noted that the working section of the tip may be flexible, with the axis of the longitudinal working section curved with flexing of the tip/rod.

The inventors discovered that there are at least four aspects of improved polymer tip/rod that will improve vibration/sound wave propagation rate and increase agitation force.

The cross-section geometry of the polymer tip/rod provides multiple sharp angles/edges. When the multitudes of vibrating wave come down through the tapered main shaft (axial direction), the tapered tip/rod produces and amplifies (acoustic horn effect) longitudinal wave propagation (Journal of Physics, Conference Series 744 (2016) 012036 by Michael K Kalkowski, etc). In a very confined/narrow root canal space, the tip/rod needs to propagate transverse vibration wave in order to produce stronger agitating force to loosen up smear layer, to generate greater vortex effect in reagent solution and force solution to release more singular oxygen. The round tip/rod cross section is not very good for this transverse vibrating wave propagation. The inventors developed various cross section designs that preserve longitudinal acoustic horn vibration wave propagation and yet amplifying the transverse vibration wave propagation.

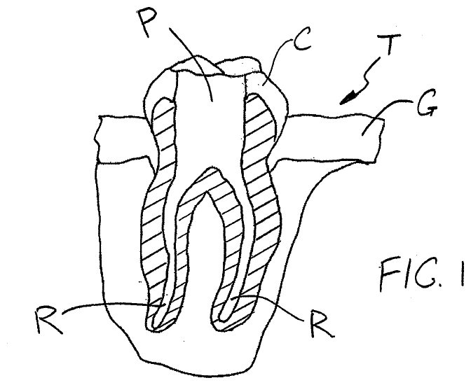

Referring to the drawings, e.g., FIGS. 7A (partial sectional view) to 7C, the inventive endoactivator tool 10 is designed and configured for activating intracanal reagents in a dental root canal system (see e.g., FIG. 1) during endodontic procedures, with the tool 10 comprising a coupler 12, shaped and configured to receive or be received by a driving portion 4 of a driver 3 (similar to that shown in FIG. 2B, and as disclosed in U.S. Pat. No. 8,388,345B2, which has been incorporated by reference herein) to positively connect the tool 10 directly to a vibrated member 4 of the driver 3 (see, FIG. 7C), wherein the coupler 12 has a vibration axis V about which the coupler 12 laterally oscillates to vibrate when the driver 3 is activated; a flexible activator tip 14 having a proximal end 15 connected to the coupler 12 and extending distally from the coupler 12 to terminate at a most distal end 16, wherein the activator tip 14 being shaped such that when the driver 3 is activated, the coupler 12 will induce vibrations in at least an activating portion 18 of the activator tip 14, wherein the activating portion 18 comprises at least one offset section (20a, 20b) displaced from the vibration axis V when view at a first plane (Y-X plane) including the vibration axis V, wherein the activating portion 14 has a length extending through a prepared dental root canal and a diameter sufficiently smaller than the diameter of the prepared root canal such that the activating portion can vibrate in the dental root canal when activated, and wherein the activating portion 14 being made from a flexible, non-cutting material having a hardness less than the hardness of a root canal wall such that the material will not damage the walls of the canal during use of the tool. A shield 17 is provided as an apron to cover the connection of the driving member 4 and the coupler 12.

In one embodiment, the inventive endoactivator tool has an offset section (20a, 20b) that comprises at least one curved section (20a, 20b), wherein a longitudinal axis A running through the center of the body of the activating portion 14 is curved when viewed at the first plane (Y-Z plane) including the vibration axis V. For example, as illustrated in FIG. 7A, the longitudinal axis of the curved section of the activating portion 18 meanders laterally in a wavy, snaking manner when viewed at the first plane including the vibration axis, such as in a sinusoidal profile, which may be symmetrical or asymmetrical (as shown in FIG. 7A) about the vibration axis V. The activating portion 18 may have a first curved section 20a closer to the proximal end 15 and a second curved section 20b closer to the most distal end 16, wherein the longitudinal axis A at the first curved section 20a and the longitudinal axis at the second curved section 20b alternate in directions of curvature when viewed at the first plane (Y-Z) including the vibration axis V. In the illustrated embodiment, the longitudinal axis A at the first curved section 20a has a first curvature greater than a second curvature of the longitudinal axis A at the second curved section 20b. To improve agitation of reagents in a dental root canal system, the proximal end of the activating portion 18 is connected to a location X on the coupler 12 displaced off the vibration axis V, and/or the most distal end of the activating portion 18 extends off the vibration axis V when the activator tip is at a state not being inserted into a dental root canal. The activator tip 14 may comprise a connecting portion 19 at its proximal end 15 connecting the activating portion 18 to the coupler 12 at the location X displaced off the vibration axis.

Referring to FIG. 7B (a partial sectional view), to further enhance agitation effect in a root canal space, the activating portion 18 is connected to the coupler 12 at an angle a with respect to the vibration axis V when view at a second plane (X-Z plane) orthogonal to the first plane (Y-Z plane) including the vibration axis V.

The activator tip 14 is shaped to transmit vibrations to the activating portion 18 when activated by the driver device 3, wherein the activating portion 18 being shaped to transmit vibrations to induce cavitation and acoustic streaming in a fluid-filled dental root canal when vibrations of a sonic or ultrasonic frequency (preferably sonic frequency) are induced in said activator tip 14 to enhance deep lateral cleaning of the dental root canal. The activating portion 18 is driven to oscillate laterally about the vibration axis V, substantially in a vibration plane including the vibration axis V. In a preferred embodiment, the vibration plane corresponds to the second plane (X-Z plane shown in FIG. 7B) orthogonal to the first plane (Y-Z plane shown in FIG. 7A) including the vibration axis.

In a specific embodiment, the activating portion 18 is structured and shaped to effectively vibrate at sonic frequencies to clean the root canal system as driven by the driver 3 driving at sonic frequencies. Further, the activating portion 18 may be made of a material and/or shaped and structured to transmit light and/or heat applied from the driver 3 through the coupler 12 of the activating portion 18. The activating portion 18 can be made of one of a polymer, metal, or hybrid metal/polymer material. For example, the activating portion 18 is made from a non-metallic material, such as plastic, nylon, or aromatic polyamide.

Even with enhanced vibrating wave agitating force, there are still many very fine fissures/spaces for vibrating wave propagate into it and agitate reagent to lease more singular oxygen. Therefore, the inventors added third form of energy—photonic, besides mechanical force (vibrating polymer tip produced whipping and brushing motion/force against root canal internal wall surface) and sonic energy (sonic wave energizes reagent solution to produce more bubbles, more bubble bursting energy, therefore releasing more singular oxygen). The photonic polymer tip/rod will carry narrow spectrum of light beam through its shaft, then transmit light wave into root canal space through strategically placed portals. On the other hand, light sensitive activators are added into reagent solutions. When this photonic tip/rod is placed inside root canal space and being turned on, the light sensitive reagent will activate like a boiling or dishwasher effect. The “boiling” reagent creates tremendous cycles of bubble producing and bursting. This phenomenon is called photo-acoustic effect and resulting in more agitating force and more singular oxygen are introduced into those tiny fissure spaces otherwise mechanical and/or sonic forces alone won't be able to reach.

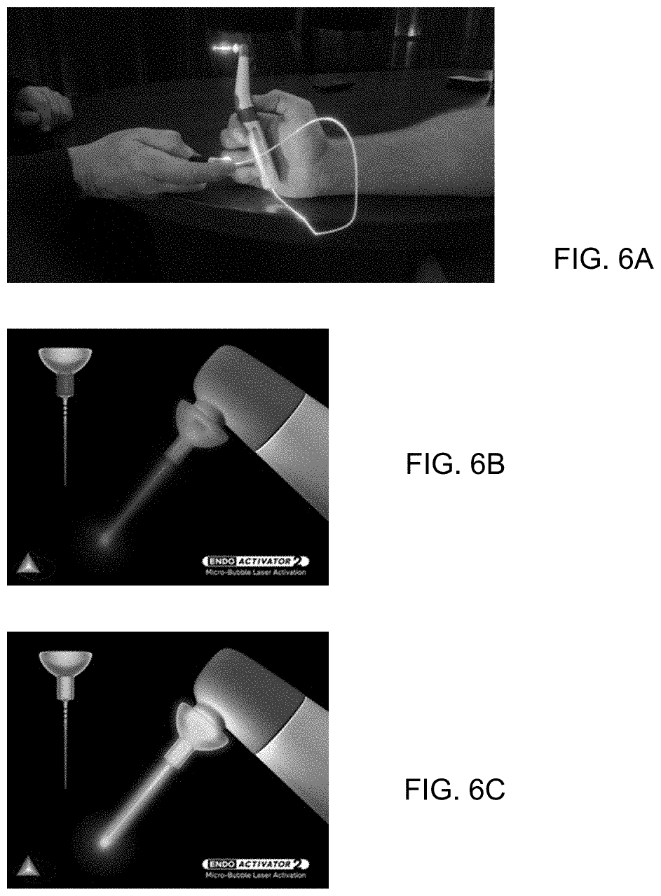

FIGS. 5A and 5B are schematic views depicting a driver device 53 and a light emitting endoactivator tip 110 in accordance with one embodiment of the present invention, producing photo-acoustic effect bringing agitating force and singular oxygen molecules to extremely hard to reach tiny spaces inside root canal system. FIG. 6A is a photographic image of an experimental setup of a light emitting driver and endoactivator tip; FIGS. 6B and 6C are further graphical renditions of light emitting endoactivator tips on drivers.

The driver device 53 has an optical fiber 51 bringing light from a source (not shown) to the driving member 54. In this embodiment, the endoactivator tip 110 includes an activating portion 114 connected to a coupler 112. The activating portion 114 includes a plurality of light emitting ports 200 distributed along the length of the activating portion 114, whereby light from the optical fiber 51 in the device 53 is transmitted through the coupler 112 to the activating portion 114, with light emitted through the ports 200.

It has long established that chemical reaction is more complete and robust at elevated temperature. This polymer, metal, or hybrid of two new tip can also conduct heat deep into root canal space to further activate reagent and force reagent releasing even more singular oxygen molecules.

In one embodiment, the activating portion 18 has a diameter at the most distal end of about 0.15 mm to about 1.0 mm. The activating portion 18 may comprise a portion that is tapered along at least a part of its length. The taper of the activating portion 18 may be constant along its length, or variable along at least a part of the length of the elongate member. The taper may be between about 0.02 mm/1.0 mm and about 0.06 mm/1.0 mm (or 2% taper to 6% taper, constant or variable within this range), tapering from a larger proximal end to a smaller distal end, wherein in a variable taper tip, the larger tapered section is closer to the distal end.

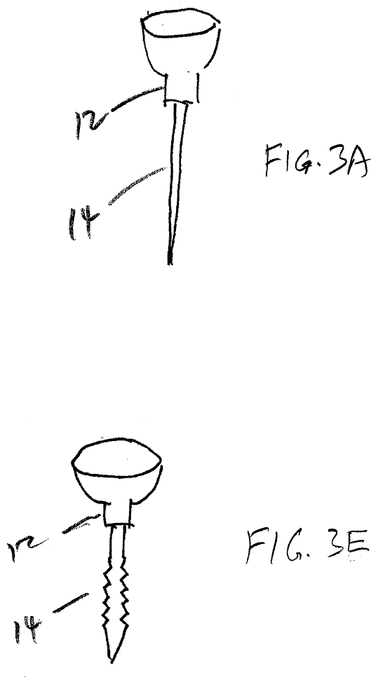

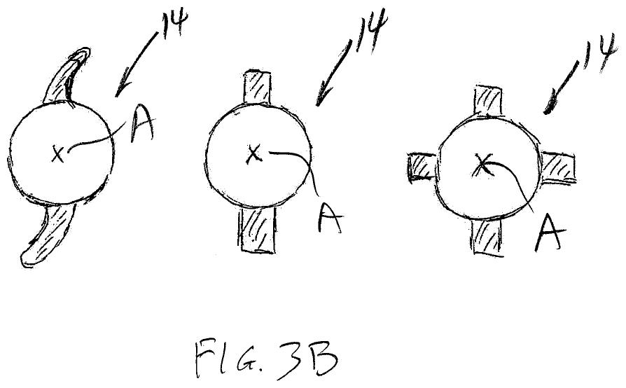

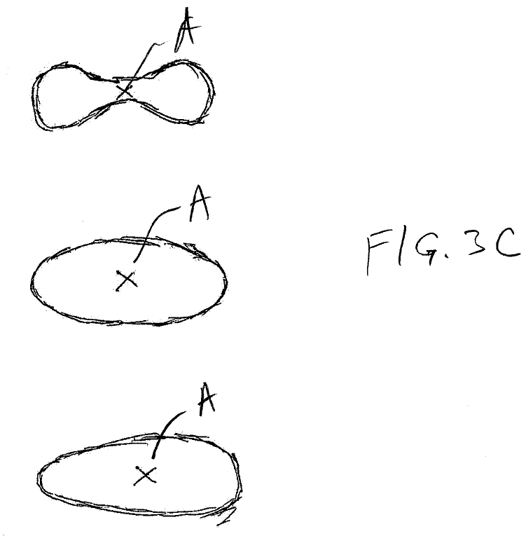

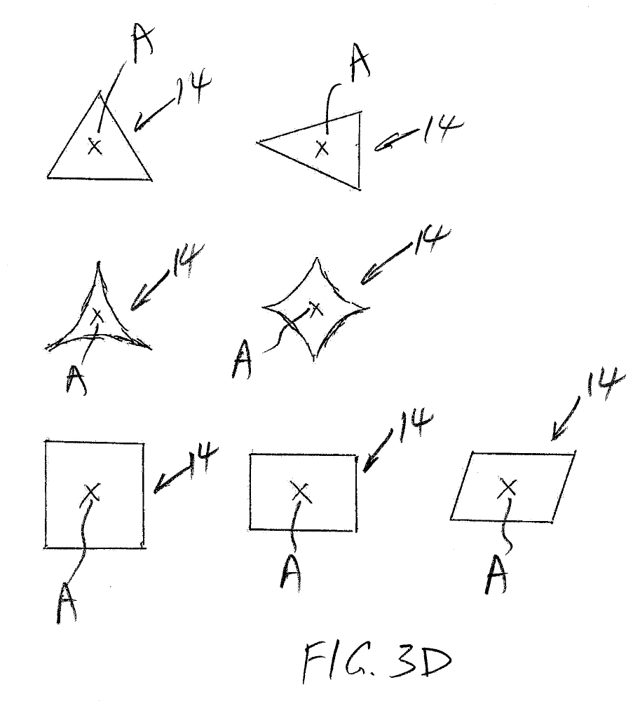

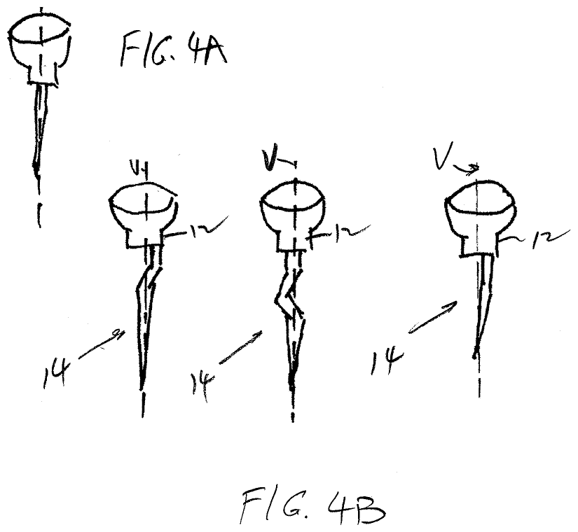

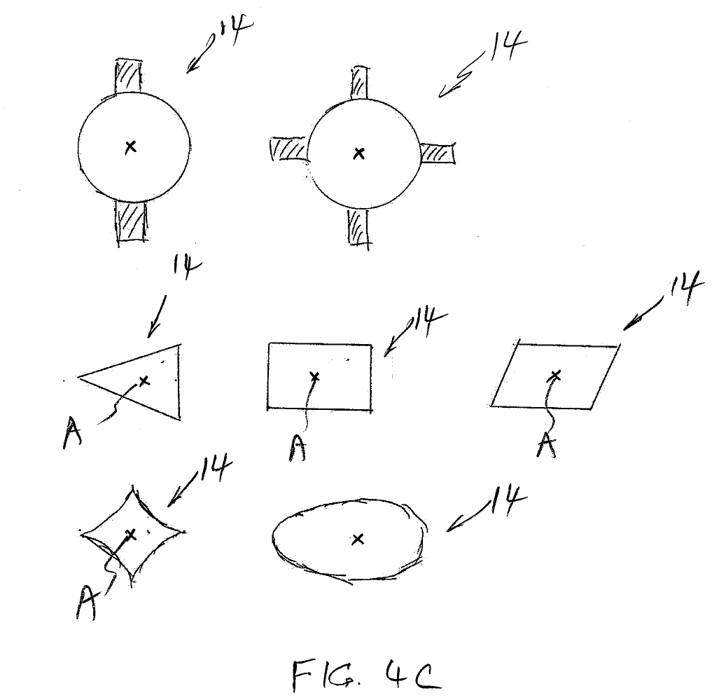

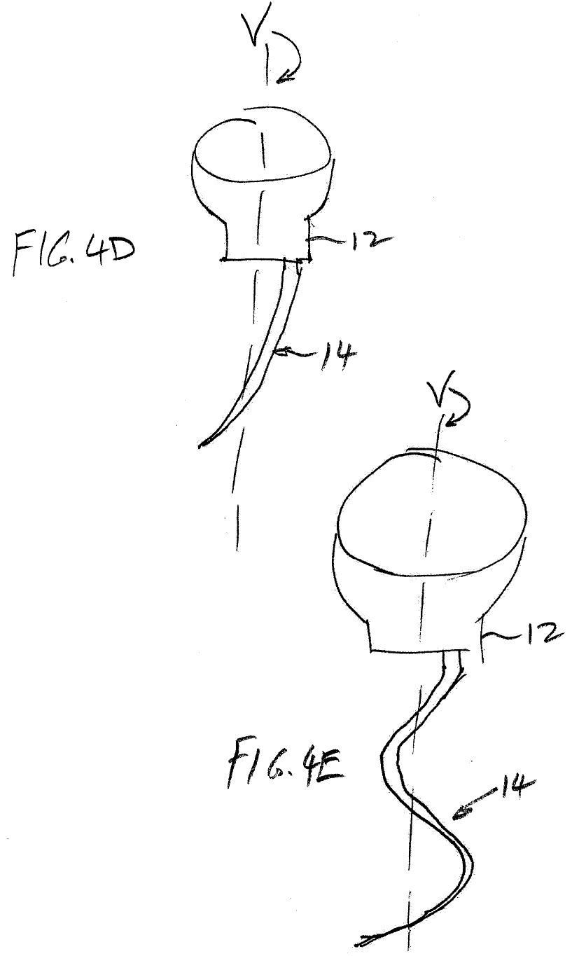

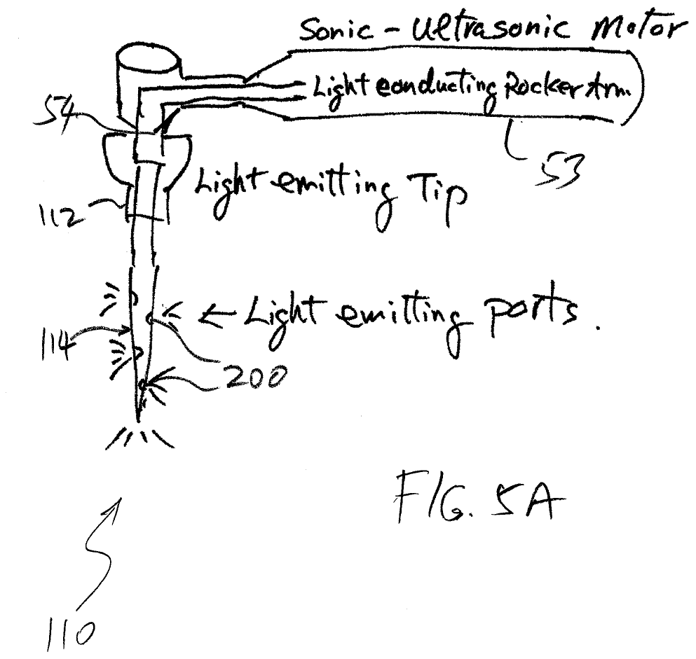

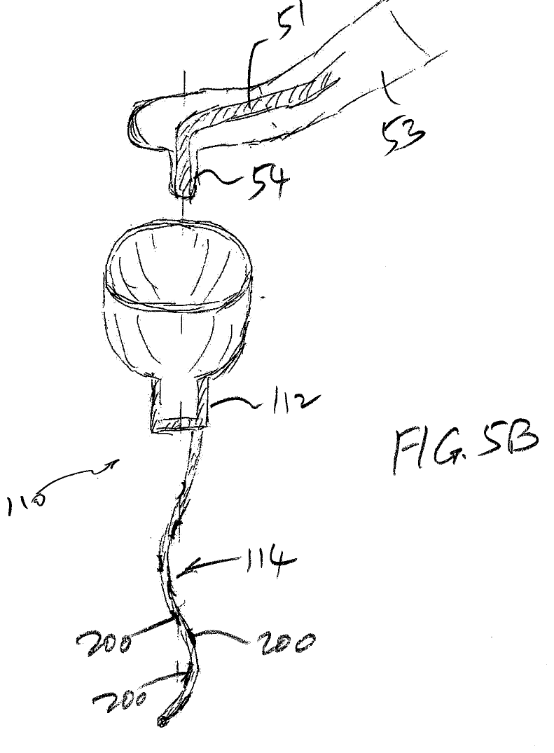

The activating portion 18 may have cross-section geometries that are symmetrical or asymmetrical. Preferred the cross-section perimeter should have a geometry that does not resemble a generally convex body having a smooth curved profile (curved surface in three-dimension) with smooth, gentle transitions of convex curvatures with respect the longitudinal axis (e.g., as shown in FIG. 3C, generally circular, elliptical, dumbbell, or a geometry without any straight line segment, representing more gentle, smoothly convex profiles, as compared to perimeters having corners or abrupt extensions/protrusions resembling protruding profiles that are relatively less gentle and less smooth profiles). Preferred geometries of the cross-section perimeter comprise more abrupt extensions/protrusions or corners defined by angled profiles (angled surfaces in three-dimension) of straight, concave and/or convex line segments resembling generally protruded profiles (protrusions or ridges on surfaces in three-dimension) (see. FIG. 3B). In a specific embodiment, the activating portion 18 has a cross-section perimeter with a geometry that is substantially a polygon (e.g., square, rectangle, pentagon, trapezoid, etc.; see, FIGS. 3D and 4C, with the exception of the egg shaped cross-section geometry), having line segments defining surfaces angled relative to one another. It is noted that the corners of the polygon may be slightly rounded or deburred, with a small curvature, to avoid a sharp, abrasive edge along the length of the activating portion 18. It has been found that the three-dimension surfaces of the activating portions having a cross-section perimeter with more abrupt profiles would produce increased agitation of a fluid-filled root canal system when the activating portions 18 are vibrated by the activating driver 3. In the illustrated cross-sections FIGS. 3B, 3C, 3D and 4C, the ‘X’ represents the longitudinal axis A through the center of each of the cross-sections of the activating portion 18 as illustrated in these figures.

The inventive activator tip disclosed herein is applied to clean the root canal system of a tooth of a living patient. The present invention is further directed to a method for cleaning a root canal system of a tooth of a living patient prior to three-dimensional filling of the root canal system during an endodontic procedure; the method comprising: preparing an access cavity in the patient's tooth; exposing the orifice(s) of a root canal within the pulp chamber of the tooth; negotiating, shaping and finishing the preparation of the root canal; removing the pulp, smear layer, and if present, bacteria and related irritants from the root canal system, including placing an irrigating solution in the root canal and inserting an activator tip as disclosed herein into the solution-filled root canal, such that the activating portion 18 reaches substantially to the working length of the root canal, wherein the activator tip having an overall diameter at its most distal end less than the diameter of the apical end of the root canal such that the activating portion 18 of the activator tip can oscillate within the canal when the activating portion 18 is fully inserted in the root canal; and sonically energizing the activator tip to oscillate the activating portion 18 within the root canal at sonic speeds to thereby agitate the solution in the root canal system.

### Further Embodiments

FIGS. 3A and 3E are schematic views of tip structures in accordance with embodiments of the present invention, each having a geometry with sharp angles and edges along the active working portion for better transverse vibration wave propagation in reagent in a root canal space, with the exception of the gentle rounded cross-section geometries depicted in FIG. 3C, as discussed with the embodiments of FIG. 7 etc. The cross-sections depicted in FIGS. 3B and 3D are preferred cross-sections of the activating portion 18 in an endoactivator tip in accordance with the present invention.

FIG. 4A is a schematic view of a current centered tip. FIGS. 4B, 4D and 4E are schematic views of tip structures in accordance with additional embodiments of the present invention, each having a geometry with an off-centered active working tip portion (activating portion) for vibrational agitation for greater and more random envelope of motion which causing more agitating force on reagent in a root canal space. Similar to the earlier described embodiments, FIG. 4C shows possible cross-sections of the activating portion of the endoactivator tips depicted in FIGS. 4B, 4D and 4E.

FIG. 3A, FIG. 3E, FIG. 4B, FIG. 4D and FIG. 4E illustrates the sequence of development of endoactivator tips leading to the embodiment of FIG. 4E, which resembles the embodiment of FIG. 7

In summary, the inventive endoactivator tip combines up to four energy forces together, Mechanical-Sonic-Photonic-Thermo, and introduce these forces deep into hard to reach root canal spaces, causing more vigorous reagent reaction and yielding more complete smear layer removal and more satisfying disinfection result.

While the present invention has been described above in connection with the illustrated embodiments, the scope of patent invention covers all possible present and future variations and improvements that is apparent from the disclosure above. While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

1. An endoactivator tool for activating intracanal reagents in a dental root canal system during endodontic procedures, the tool comprising:
a coupler, shaped and configured to receive or be received by a portion of a driver to positively connect the tool directly to a vibrated member of the driver, wherein the coupler has a vibration axis about which the coupler laterally oscillates to vibrate when the driver is activated;
a flexible activator tip having a proximal end connected to the coupler and extending distally from the coupler to terminate at a most distal end, wherein the activator tip being shaped such that when the driver is activated, the coupler will induce vibrations in at least an activating portion of the activator tip,
wherein the activating portion comprises at least one offset section displaced from the vibration axis when viewed at a first plane including the vibration axis,
wherein the activating portion has a length extending through a prepared dental root canal and a diameter sufficiently smaller than the diameter of the prepared root canal such that the activating portion can vibrate in the dental root canal when activated, and
wherein the activating portion being made from a flexible, non-cutting material having a hardness less than the hardness of a root canal wall such that the material will not damage the walls of the canal during use of the tool.

2. The endoactivator tool as in claim 1, wherein the offset section comprises at least one curved section, wherein a body of the activating portion has a longitudinal axis running through a center of the body of the activating portion is curved when view at the first plane including the vibration axis.

3. The endoactivator tool as in claim 2, wherein the longitudinal axis of the curved section of the activating portion meanders laterally in a wavy, snaking manner when viewed at the first plane including the vibration axis.

4. The endoactivator tool as in claim 3, wherein the longitudinal axis of the curved section of the activating portion meanders in a sinusoidal profile.

5. The endoactivator tool as in claim 2, wherein the activating portion has a first curved section closer to the proximal end and a second curved section closer to the most distal end, wherein the longitudinal axis at the first curved section and the longitudinal axis at the second curved section alternate in directions of curvature when viewed at the first plane including the vibration axis.

6. The endoactivator tool as in claim 5, wherein the longitudinal axis at the first curved section has a first curvature greater than a second curvature of the longitudinal axis at the second curved section.

7. The endoactivator tool as in claim 1, wherein the proximal end of the activating portion is connected to a location on the coupler displaced off the vibration axis, and/or the most distal end of the activating portion extends off the vibration axis when the activator tip is at a state not being inserted into a dental root canal.

8. The endoactivator tool as in claim 1 wherein the activator tip comprises a connecting portion at its proximal end connecting the activating portion to the coupler at the location displaced off the vibration axis.

9. The endoactivator tool as in claim 1, wherein the activator tip is shaped to transmit vibrations to the activating portion when activated; wherein the activating portion being shaped to transmit vibrations to induce cavitation and acoustic streaming in a fluid-filled dental root canal when vibrations of a sonic or ultrasonic frequency are induced in said activator tip to enhance deep lateral cleaning of the dental root canal.

10. The endoactivator tool as in claim 1, wherein the activating portion is driven to vibrate substantially in a vibration plane including the vibration axis, wherein the vibration plane corresponds to a second plane orthogonal to the first plane including the vibration axis.

11. The endoactivator tool as in claim 1, wherein the activation section is structured and shaped to effectively vibrate at sonic frequencies to clean the root canal system as driven by the driver at sonic frequencies.

12. The endoactivator tool as in claim 1, wherein the activating portion is made of a material and/or shaped and structured to transmit light and/or heat applied from the driver through the coupler of the activating portion.

13. The endoactivator tool as in claim 1, wherein the activating portion is made of one of a polymer, metal, or hybrid metal/polymer material.

14. (canceled)

15. (canceled)

16. (canceled)

17. The endoactivator tool as in claim 1, wherein the activating portion comprises a portion that is tapered along at least a part of its length.

18. The endoactivator tool as in claim 17, wherein the taper of the activating portion is constant along its length.

19. (canceled)

20. (canceled)

21. The endoactivator tool as in claim 1, wherein the activating portion has a cross-section perimeter with a geometry that does not resemble a generally convex body having a smooth curved profile (curved surface in three-dimension) with smooth, gentle transitions of convex curvatures with respect to the longitudinal axis (e.g., generally circular, elliptical, dumbbell, or a geometry without any straight line segment, representing more gentle, smoothly convex profiles, as compared to perimeters having corners or abrupt extensions/protrusions resembling protruding profiles that are relatively less gentle and less smooth profiles).

22. The endoactivator tool as in claim 21, wherein the activating portion has a cross-section perimeter comprising more abrupt extensions/protrusions or corners defined by angled profiles (angled surfaces in three-dimension) of straight, concave and/or convex line segments resembling generally protruded profiles (protrusions or ridges on surfaces in three-dimension).

23. The endoactivator tool as in claim 22, wherein the activating portion has a cross-section perimeter with a geometry comprising line segments defining surfaces angled relatively to one another.

24. (canceled)

25. The endoactivator tool as in claim 1, wherein the activating portion is connected to the coupler at an angle with respect to the vibration axis when viewed at a second plane orthogonal to the first plane including the vibration axis.

26. A method for cleaning a root canal system of a tooth of a living patient prior to three-dimensional filling of the root canal system during an endodontic procedure; the method comprising:
preparing an access cavity in the patient's tooth;
exposing the orifice(s) of a root canal within the pulp chamber of the tooth;
negotiating, shaping and finishing the preparation of the root canal; and
removing the pulp, smear layer, and if present, bacteria and related irritants from the root canal system, comprising:
placing a reagent solution in the root canal;
inserting an activator tip as in claim 1 into the solution-filled root canal, such that the activating portion reaches substantially to the working length of the root canal, wherein the activator tip having an overall diameter at its most distal end less than the diameter of the apical end of the root canal such that the activating portion of the activator tip can oscillate within the canal when the activating portion is fully inserted in the root canal; and
sonically energizing the activator tip to oscillate the activating portion within the root canal at sonic speeds to thereby agitate the solution in the root canal system.
